(19) United States
(12) Patent Application Publication
(10) Pub. No.: US 2008/0259411 A1
(43) Pub. Date: Oct. 23, 2008

(54) Scanner Arrangement

(75) Inventor: Anders Karlsson, Goteborg (SE)

Correspondence Address: KNOBBE MARTENS OLSON & BEAR LLP, 2040 MAIN STREET, FOURTEENTH FLOOR, IRVINE, CA, 92614, US

(73) Assignee: Nobel Biocare Services AG, Zurich-Flughfen (CH)

(21) Appl. No.: 11/576,450

(22) PCT Filed: Sep. 22, 2005
(86) PCT No.: PCT/SE2005/001390

§ 371 Date: Sep. 19, 2007

(30) Foreign Application Priority Data
Sep. 30, 2004 (SE) 0402359-4

(51) Int. Cl. H04N 1/04

(52) U.S. Cl. 358/474

(57) ABSTRACT

A scanner arrangement which is designed to scan only one part at a time in order to permit scanning results of a model or die-shaped unit consisting of two or more parts which can be joined together or taken apart and which can have different longitudinal inclination axes and/or configurations. The scanner has, for each respective part, a support member adjustable with different inclinations in order to adapt the respective part's longitudinal inclination axis to a longitudinal displacement movement effected by the scanner's contour-sensing member relative to the supported part at the same time as the contour-sensing member is set at an angle with respect to a rotation axis for the part. The support member is designed to movably support the respective part and a unit with a grid surface and to be adjustably arranged with the same inclination as the part in question and a selected height position. After contour sensing and removal of the respective part, the scanner is designed to rescan a portion which is located on the grid surface and which is continuous with the respective part's position in space. The grid pattern is designed to indicate unique positions • for the data thus scanned. The scanner or a computer unit connected to it transforms, by means of an algorithm, the positions corresponding to the positions which are present in the model or. the die-shaped unit and which, in subsequent signal or data generation, form the basis for the dental bridge structure. By means of the invention, it is readily possible to use one-part scanners to scan dental objects with several parts, without the scanner functions having to be reconfigured. The handling principles for model and tool production can be retained, likewise the handling in the computer environment in the manufacture of the dental product. Costs can be kept low, and precision requirements and speed of production can be maintained.

The present invention relates to a scanner arrangement which is designed to scan only one part at a time, for example a part formed as a tooth remnant, in order to permit scanning results of a model or die-shaped unit, for example of a tooth remnant structure, with two or more parts which can be joined together and taken apart and which can have or represent different longitudinal inclination axes and/or configurations. The scanner has, for each respective part, a support member adjustable with different inclinations in order to adapt the longitudinal inclination axis of the part to a longitudinal displacement movement effected by the scanner's contour-sensing member relative to the supported part, at the same time as the contour-sensing member is set at an angle with respect to a used axis of rotation for the respective part.

The scanner in question can be of a known type, and reference may be made to the scanners sold on the general market by the Applicant of the present patent application and designated by the names “PICCOLO” and “M50”. The scanners can be of the type which are provided with sensing needles which mechanically cooperate with the contour (cf. said scanner types). Alternatively, the scanner can be of another type and, for example, work with optical sensing of the contour.

The scanner types in question have hitherto been used for producing dental products consisting of or comprising just a single part, for example tooth remnant part, tooth crown, etc. In connection with these types of scanners, however, there is a need to be able to work with a dental structure which comprises or represents more than a single part, for example a dental bridge which is designed with or comprises several parts, for example tooth remnant parts, which are to constitute attachments for the dental bridge or other fixtures which comprise parts with different axes of inclination and/or structures. In such a case, the contour of the respective part must be able to be scanned and, in scanners with rotating axis about each part's longitudinal axis and sensing members which during rotation of the unit are at the same time longitudinally displaced in the longitudinal axis of the part, there is a need to be able to produce a suitable scanning function. The object of the present invention is to solve these problems, among others.

There is also a need to be able to use previously known one-part scanners without reconfiguration of these. There is therefore a need for existing hardware to be able to be used without substantial modification. The same handling and production principles must be able to be used in connection with model or tool productions of waxed models. The file formats forming the basis for the handling in the computer environment and the production of the dental product (dental bridge) in question must be able to be used without substantial modifications. The production of the prosthetic structure must be able to be kept to an advantageous price level. Accuracy, for example of 0.02 mm, and speed of production must be able to be maintained in comparison with other types of scanners. The invention also solves this problem.

The feature that can principally be regarded as characterizing an arrangement according to the invention is that the scanner's support member is designed to movably support the respective part and a unit with a grid surface and to be adjustably arranged with the same inclination as the part in question and a selected height position. Further features are that, after contour-sensing and removal of the respective part, the scanner is designed to rescan a portion which is located on the grid surface and which is continuous with the respective part's position in space, and that the grid pattern is designed to indicate unique positions for the data thus scanned. The invention is finally characterized in that the scanner or a computer unit connected to it transforms, by means of an algorithm, the positions corresponding to the positions which are present in the model or the die-shaped unit and which, in subsequent signal or data generation, form the basis for the prosthetic structure in question, for example a dental bridge structure.

In a preferred embodiment, the support member(s) comprise(s) a tiltable fixture base unit, here called the first unit, the grid surface unit, here called the second unit, and a support unit, here called the third unit, for supporting the bridge or tooth replacement. The cooperating units are thus arranged with interfaces which establish well-defined positions when the different units are combined or coupled together. The die in question supports the parts to be scanned in a removable manner so that each part secured in the die in question can be applied to the scanner which scans the part's contour. The part thus scanned can be removed and the next part applied in the die, after which the second part is scanned, etc. Each part's contour and each part's position on the grid surface in question is scanned and input into the computer environment. The parts thus individually scanned with associated data for their positions on the grid surface are combined with the aid of the fact that said positions are unique on the grid surface. In the computer environment, the different scanned parts and the positions can thus be put together in a manner known per se and with an algorithm known per se. In this way, the model or the die can be input into the computer environment where it is possible, in a manner known per se, to form the prosthesis in question which is to be applied to the scanned tooth remnant structure. In a similarly known way, the produced fixture can be represented in the computer environment with signals which are used for producing the prosthesis in question in a CAD context.

Further developments of the inventive concept are set out in the attached dependent claims.

By means of what has been proposed above, consecutive scannings can be incorporated in a common coordinate system despite the fact that a scanner is used which can scan only one part at a time. The scanned object can span across an entire bridge and can use the one-part scanner's ability for double scanning. The spatial position of the object in question can thus be achieved while having to scan fewer parts of the object in its entirety. The known scanner can be provided with comparatively simple supporting parts for the object in question. In a preferred embodiment, three support members are used which cooperate in a manner characteristic of the invention.

A presently proposed embodiment of an arrangement having the features characteristic of the invention will be described below with reference to the attached drawings, in which

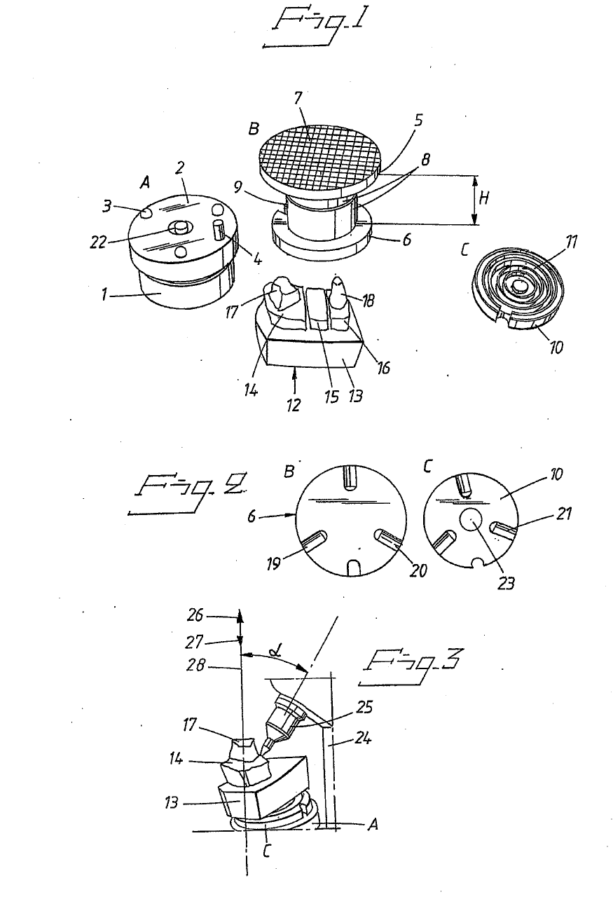

FIG. 1 shows, in a perspective view obliquely from above, the first, second and third units of the supporting member, and a model or die-shaped unit with parts which can be applied and removed and which are to be scanned,

FIG. 2 shows, in a horizontal view, the underside of the second and third units according to FIG. 1, via which the second and third units can cooperate with the top of the first unit,

FIG. 3 shows, in a perspective view obliquely from above, a fixture in a scanner with contour-sensing member angled obliquely with respect to the remaining part on the model or the die-shaped unit,

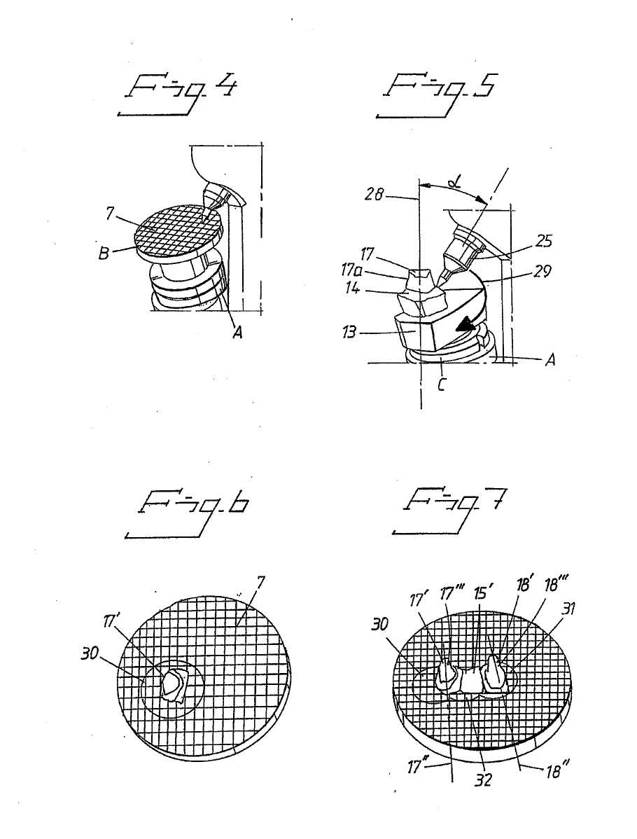

FIG. 4 shows, in a perspective view obliquely from above, the second unit applied on the first unit and adopting a tilting position or inclined position corresponding to the tilting position or inclined position of the first and second units in FIG. 3,

FIG. 5 shows, in a perspective view obliquely from above and from the side, the scanning and rotation functions in the scanner where the die with a unit has been applied for scanning the part,

FIG. 6 shows, obliquely from above, the grid surface of the unit according to FIG. 4 and indicating the scanned part together with the part's positioning on the grid surface,

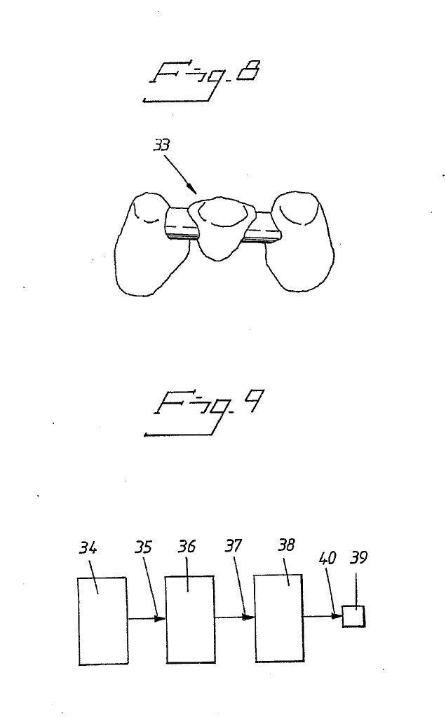

FIG. 7 shows, obliquely from above, the grid surface according to FIG. 6, where the different parts on the model or the die have been brought together to mutual positions corresponding to the positions in the model or on the die, which combination has been effected with the aid of scanned positions on the grid surface,

FIG. 8 shows, in a perspective view obliquely from above, an example of a prosthetic structure, for example in the form of a dental bridge, which is produced for application on the configuration according to FIG. 7 in a computer environment, and

FIG. 9 shows a schematic representation of the principle for signal generation from a scanner to computer equipment, which in turn is connected or connectable to a CAD-based production system, from which the dental bridge or the like according to FIG. 8 is obtained.

In FIG. 1, letter A designates a fixture base unit, here called the first unit. The unit comprises an attachment part 1 which can be applied in a known manner to a scanner. A disk-shaped part 2 is arranged on the attachment part. The unit 1 has a hollowed seat (not shown in the figure), and the unit 2 has a convex underside of likewise known type. The convex underside and the hollowed surface allow the unit 2 to be applied in different tilting positions or inclined positions. On its top face, the unit 2 has position-determining members in the form of three ball-shaped parts arranged at the periphery and a guide pin 4 likewise arranged at the periphery. The ball-shaped parts are uniformly distributed along the periphery, and the guide pin 4 is placed between two of the ball-shaped parts. FIG. 1 also shows a unit B which is provided with first and second disk-shaped parts 5, 6. The upper disk-shaped part supports a grid surface 7. The disk-shaped parts are arranged on telescopic parts by means of which the disks 5 and 6 can be displaced vertically in relation to one another. The telescopic principle in question can be achieved using two tubular parts 8. The parts 8 are also provided with a locking member 9 by means of which the parts 8 and thus the disks 5 and 6 can be assigned the desired height positions H and can be locked in the chosen positions. In this way, the grid surface can be assigned different height settings in the actual scanner (see below). The grid or screen 7 on the disk 5 can be designed in different ways. In the present case, there is a checkered pattern which has been obtained by parallel depressions in the disk material intersecting one another at right angles.

Alternatively, undulating lines, circular lines, etc., can be used. FIG. 1 also indicates a third unit C which consists of a bridge fixture in which a bridge, model, die, etc., is to be applied. The unit consists of a disk-shaped part 10 which is provided with parallel grooves 11 extending in circles on the top face. The grooves are arranged to permit fixing of the model, die, etc., in question. FIG. 1 also indicates a model, die-shaped unit, etc., having designation number 12. The unit 12 comprises a base part 13 on which parts 14, 15 and 16 have been arranged such that they can be applied and removed in accordance with the above. The parts 14 and 16 support parts 17 and 18 which constitute the parts which are to be scanned by the scanner in question and are assigned their spatial positions in a computer environment into which the scanned result is input.

FIG. 2 shows the underside of the disk-shaped unit 6 according to FIG. 1. Said underside has position-determining members for the unit B relative to the unit 2 in the unit A. The unit 6 has recesses or depressions 19, 20 which can cooperate with the members 3, 4 on the top face of the unit 2. On its underside, the unit C is provided with corresponding position-determining members 21. In addition to the position-determining members arranged at the periphery, the units A (FIG. 1) and the unit C have central position-determining members 22 and 23, respectively. With said position-determining members, interfaces are obtained for the units B and C with respect to the unit A, which interfaces mean that the units B and C can be attached to the unit A in only one possible way.

FIG. 3 shows parts of a one-part scanner 24 of the type mentioned in the introduction. The scanner is equipped with a contour-sensing member which is displaceable in directions 26 which have been indicated by arrows 26, 27. In the present case, the sensing member supports, in a known manner, a needle-shaped member which cooperates mechanically with the contour of that part which is to be scanned. In FIG. 3, the base unit 12 (see FIG. 1) is applied on the units A and C in accordance with the above. From the unit 12, two parts 15, 16 (FIG. 1) have been removed so that only the part 14 is left.

By means of the supporting members A and C, the part 17 can be adjusted to the axis of rotation of the scanner so that its longitudinal axis coincides with the axis of rotation. Said axes have both been indicated by 28 in FIG. 3. The sensing member is inclined in relation to said axis by an angle α which is preferably chosen as 45°. In a first stage, the scanner is arranged to receive the unit 13 with the part 14. The scanner is designed to allow the die-shaped unit to be received such that a setting position corresponding to the lowest boundary line can be obtained. This positioning is chosen for the part with the lowest boundary line and can in principle be done in the same way as when scanning a die with just one unit.

In accordance with FIG. 4, the scanner is designed to receive the unit B in order to set the maximum height that can exist for the unit 12. The grid (disk 5) is fixed in this position by said locking member 9, which can be a locking screw. The grid 7 has to be kept in this position until all parts of the bridge are scanned.

The scanner is designed such that, after said adjustment step, it can once again receive the die 13 with the part 14 according to FIG. 3. The height of the part 14 in question must be adjusted. Correspondingly, the grid 7 (disk 5) must be controlled so that the grid can turn in an acceptable manner, see FIG. 4. Thereafter, the units 13 and 14 can be applied to the supporting member in question according to FIG. 5, and the scanner is arranged to start scanning of the part 17. During the scanning, the supporting members and thus the units 13 and 14 and the part 17 are rotated around the axis 28, which is preferably a vertical axis. The needle or member 25 is displaced in the height direction (cf. 26 in FIG. 3). The scanner is designed in such a way that, after this scanning of the contour surface 17a of the part 17, it permits insertion of the unit B with the grid 7 in a corresponding tilting position as in FIG. 5. In the position thus obtained for the surface 7, the scanner is designed to execute a rescan, which allows a part of the grid surface to be scanned by the needle. This scanning represents the spatial position that the part 17 had when it was scanned according to FIG. 5.

The scanning of part 17 is thus carried out, likewise its position in space. Corresponding scans of other parts and their positions in space are carried out one by one. When scanning the part 16, the parts 15 and 17 are thus removed and corresponding individual scanning is carried out on the part 18.

FIG. 6 shows, in a computer environment, in a manner known per se, the scanned surface 7 and the scanning 17′ related to it, and the scanned grid portion 30 related to this part. Parts and portions scanned individually in this way are applied in the computer environment and combined in same with an algorithm of a type known per se. In FIG. 7, in addition to the configuration of the part 17 indicated by 17′ and the associated portion 30, the part 18 is indicated by 18′ and its portion by 31, and the part 15 by 15′ and its portion by 32. Each of the scanned shapes relates to a scanned area (circular area) on the grid. At the time according to FIG. 6, there is no correspondence between the consecutive scannings of A, B and C, and instead these can be regarded as “floating” in space. Said grid 7 is thus executed such that, in the scanner, only one position arises on the pattern where respective scanned data can be input. The automatic algorithm executes the transformation and brings the scanned parts and portions to the correct mutual position. The scanned parts and portions in this way acquire positions which correspond to the reality according to the model or the die-shaped unit. The scanned parts can thus be positioned in their correct positions in the coordinate system. With this as the starting point, the work with the bridge structure can be started.

According to FIG. 8, a bridge structure or dental bridge structure 33 is constructed in a manner known per se and is intended for the fixed scanning according to FIG. 7. This can be done in a manner known per se using well established methods, programs, etc.

FIG. 9 shows the principle of scanning a tooth remnant model, input into a computer environment, production of a prosthesis for the model and manufacture, for example in the PROCERA® system, according to CAD principles. In FIG. 9, reference number 34 designates a scanner of the above-mentioned type. Information on the shape of the scanned structure is indicated by 35. This information is sent to a computer unit 36 where it is possible to execute modifications, dental bridge work, etc., in a manner known per se and effect signal transmission 37 to a CAD system 38. A prosthetic product in question (dental bridge or the like) emerges from the CAD environment.

The direction of transportation to the user in question is indicated by 40. Said parts and signals can be varied in different ways and do not affect the invention as such. The scanned parts 17′ and 18′ input into the computer environment can, in a known manner, have different longitudinal inclination axes 17″, 18″ and constructions 17′″, 18′″.

The invention is not limited to the embodiment described above by way of example, and instead it can be modified within the scope of the attached patent claims and the inventive concept.

1. A scanner arrangement which is designed to scan only one part at a time, for example a part formed as a tooth remnant, in order to permit scanning results of a model or die-shaped unit, for example of a tooth remnant structure, with two or more parts which can be joined together or taken apart and which can have different longitudinal inclination axes and/or configurations, the scanner having, for each respective part, a support member adjustable with different inclinations in order to adapt the longitudinal inclination axis of the part to a longitudinal displacement movement effected by the scanner's contour-sensing member relative to the supported part at the same time as the contour-sensing member is set at an angle with respect to a rotation axis for the part, characterized in that the support member (A) is designed to movably support the respective part and a unit (B) with a grid surface and to be adjustably arranged with the same inclination as the part in question and a selected height position, and, after contour sensing and removal of the respective part, the scanner is designed to rescan a portion which is located on the grid surface and which is continuous with the respective part's position in space, in that the grid pattern is designed to indicate unique positions for the data thus scanned, in that the scanner or a computer unit connected to it transforms, by means of an algorithm, the positions corresponding to the positions which are present in the model or the die-shaped unit and which, in subsequent signal or data generation, form the basis for the structure in question, for example a dental bridge structure.

2. The arrangement as claimed in patent claim 1, characterized in that the support member(s) comprise(s) a tiltable fixture base unit (A), here called the first unit, the grid surface unit (B), here called the second unit, with adjustment in the vertical direction, and a support unit (C), here called the third unit, for supporting the bridge or tooth replacement.

3. The arrangement as claimed in patent claim 2, characterized in that the grid surface unit (B) or first unit and the bridge or tooth replacement support unit (C) or third unit have interfaces which can be connected to the fixture base unit (A) or first unit and which are arranged to establish well-defined positions between the combinable or connectable units.

4. The arrangement as claimed in patent claim 1, characterized in that the model consists of a die-shaped unit made of a material, for example wax or plaster, in which the parts can be applied and from which they can be removed.

5. The arrangement as claimed in patent claim 1, characterized in that the model or the die-shaped unit with the one of said parts can, in a first stage, be applied to the bridge or tooth replacement support unit (C) or third unit, which in turn is applied in the scanner on the tiltable fixture base unit (A) or first unit.

6. The arrangement as claimed in patent claim 1, characterized in that the grid surface unit (B) or second unit can be applied, in a second stage, to the fixture base unit (A) or first unit.

7. The arrangement as claimed in patent claim 6, characterized in that the grid surface unit (B) or second unit has two end portions, in that a first disk-shaped element supporting the grid (screen) is arranged at the first end portion, and in that a securing or fixing member is arranged at the second end portion and can cooperate with a corresponding element on the tiltable fixture base unit (A) or first unit, and in that the grid surface unit is provided with telescopic parts with which the first disk-shaped element can be adjusted and locked by a locking member, for example a locking screw, in the chosen vertical position above the tiltable fixture base unit (A) or first unit.

8. The arrangement as claimed in patent claim 7, characterized in that the grid surface unit is designed to assume said locked position until the parts belonging to the tooth replacement structure are scanned.

9. The arrangement as claimed in patent claim 7, characterized in that, in an initial stage of the scanning, the part with the lowest boundary line is chosen first.

10. The arrangement as claimed in patent claim 9, characterized in that, it after the initial stage with adjustment to said lowest boundary line and locking position of the surface supporting the grid is arranged for application of the part in question and adjustment of the height of the actual boundary line and removal of the thus adjusted part and insertion of the grid surface unit and checking whether the grid surface unit is rotatable in the intended manner.

11. The arrangement as claimed in patent claim 9, characterized in that the scanner is designed in order, after height adjustment of the first and third units and checking of the second unit, to receive appropriate rotatability for the actual part for scanning.

12. The arrangement as claimed in patent claim 11, characterized in that the scanner is arranged to receive the second unit, after scanning of the part, in the same adjustment or inclination position for the first unit and to scan a portion of the second unit's grid surface with the same scanning setting for the contour-sensing member, and in that the scanner is designed to execute the same sequence of measures for each part in the model.

13. The arrangement as claimed in patent claim 12, characterized in that scanning data relatable to the contour scanning of the respective part and its position on the grid surface can be combined for reproduction in a computer environment.

14. The arrangement as claimed in patent claim 13, characterized in that a prosthetic structure, for example a dental bridge or a dental bridge arrangement, can be applied to scanned model parts which in the reproduction in the computer environment are oriented in space in a similar way to the model's or die-shaped unit's parts to the reproduction.

15. The arrangement as claimed in patent claim 14, characterized in that the computer environment includes a program or arrangement for generating manufacturing information for production equipment, for example CAD equipment.

16. The arrangement as claimed in patent claim 1, characterized in that the scanner consists of a known one-part scanner.
